(19) United States
(12) Patent Application Publication
(10) Pub. No.: US 2014/0083967 A1
(43) Pub. Date: Mar. 27, 2014

(54) CRANE MACHINE WITH ARTICULATED ARM

(71) Applicant: CORMIDI S.R.L., Roccadaspide (Salemo) (IT)

(72) Inventor: Armando Cormidi, Roccadaspide (Salerno) (IT)

(73) Assignee: CORMIDI S.R.L., Roccadaspide(Salemo) (IT)

(21) Appl. No.: 14/031,645

(22) Filed: Sep. 19, 2013

(30) Foreign Application Priority Data
Sep. 21, 2012 (IT) RM2012A000454

(51) Int. Cl. B66C 23/62; B66F 11/04

(52) U.S. Cl. CPC B66C 23/62; B66F 11/04
USPC 212/347

(57) ABSTRACT

A crane machine with articulated arm allows a greater operating flexibility upon operating the distal end of the articulated arm and in particular the arm inverse operation and it comprises a base frame, having a supporting base for an articulated arm which in turn comprises: a first section of articulated arm, revolvingly connected to said supporting base at a first proximal end thereof; a second intermediate section of articulated arm, revolvingly connected to a first distal end of said first section at a second proximal end thereof; a third section of articulated arm, revolvingly connected to a second distal end of said second section at a third proximal end thereof, comprising, on a third distal end thereof, an attachment for a platform, a basket, a hooking or any working device apt to be operated by means of said articulated arm; and actuating means, controlled by a control system, respectively connected to said supporting base and to each one of said sections of articulated arm, for actuating and rotating each one of said sections of articulated arm and a platform, a basket, a hooking or any working device apt to be operated by means of said articulated arm, wherein one or more of said sections of articulated arm are divided into two proximal and distal half-tracts revolving one with respect to the other one around the axis of the respective section of articulated arm, one proximal half-tract thereof is fixed whereas another distal half-tract is revolving, a revolving attachment member and additional actuating means for actuating the attachment member, fastened to said half-tract at a hinge, being connected to the distal half-tract; and wherein the two half-tracts are fastened one to the other one by means of a pair of hooking plates comprising a through-hole and a fastening pin constitutes an extension of the first half-tract, so that by disassembling the fastening of the pair of plates it is possible re-mounting the second half-tract axially rotated by 180° with respect to the first half-tract, by rotating by 180° even the respective arm-actuating means.

### BACKGROUND OF THE INVENTION

1. Field of the Invention

The present invention relates to a crane machine with articulated arm, in particular of self-propelled type, able to work as crane or as support for the platform, a basket, a hooking, a lifting system, a tool, a crane device of any type, to be operated remotely.

2. Description of the State of Art

Several types of crane machines with articulated arm are known: the several arm joints allow complex operations in positions remote from the machine body. However, not in all cases the presence of several joints can guarantee the maximum operating flexibility. For example, often it is difficult to traverse laterally the distal end of the articulated arm or working with the distal end below the resting plane of the crane machine. By way of example, one thinks to the difficulty in operating a basket at the intrados of a bridge, with the crane machine arranged on the walkable plane of the bridge itself, according to the so-called inverse operation.

The British patent Nr. 1,321,051 and the Japanese patent applications Nr. JP 2002 316798 A and Nr. JP 2002 053297 describe self-propelled crane means allowing to operate a basket below a road surface, but with considerable operating difficulties.

### SUMMARY OF THE INVENTION

The technical problem underlying the present invention consists in overcoming the drawbacks mentioned with reference to the prior art.

Such problem is solved by a crane machine with articulated arm comprising a base frame, having a supporting base for an articulated arm comprising: a first section of articulated arm, revolvingly connected to said supporting base at a first proximal end thereof; a second intermediate section of articulated arm, revolvingly connected to a first distal end of said first section at a second proximal end thereof; a third section of articulated arm, revolvingly connected to a second distal end of said second section at a third proximal end thereof, comprising, on a third distal end thereof, an attachment for a platform, a basket, a hooking or any working device apt to be operated by means of said articulated arm; and actuating means, controlled by a control system, respectively connected to said supporting base and to each one of said sections of articulated arm, for actuating and rotating each one of said sections of articulated arm and a platform, a basket, a hooking or any working device apt to be operated by means of said articulated arm, wherein one or more of said sections of articulated arm are divided into two proximal and distal half-tracts, revolving one with respect to the other one around the axis of the respective section of articulated arm, one proximal half-tract thereof is fixed whereas another distal half-tract is revolving, a revolving attachment member and an additional actuating member for actuating the attachment member, fastened to said distal half-tract at a hinge, being connected to the distal half-tract.

In this above-described crane machine with articulated arm the above-mentioned half-tracts are fastened one onto the other one by means of a pair of hooking plates comprising a through-hole and a fastening pin constitutes an extension of the first half-tract, so that by disassembling the fastening of the pair of plates it is possible re-mounting the second half-tract axially rotated by 180° with respect to the first half-tract, by rotating by 180° even the respective arm-actuating means.

The above-defined crane machine allows a greater working flexibility upon operating the distal end of the articulated arm and in particular it allows the arm inverse operation.

According to a preferred example of the crane machine of the present invention, the axial rotation and the inversion of the articulated arm can be performed in an extremely simple manner, without making heavier the complexity of the crane machine.

### BRIEF DESCRIPTION OF THE DRAWINGS

The present invention will be described hereinafter with reference to an example thereof, provided by way of not limiting example, and to the enclosed drawings wherein:

FIG. 1 shows an axonometric view taken laterally of a crane machine according to the invention;

FIG. 2 shows an axonometric view taken from the bottom of the machine of FIG. 1;

FIGS. 3A and 3B illustrate two respective use modes of the crane machine of FIG. 1;

FIG. 4 shows a diagram illustrating a range of working positions of the crane machine of FIG. 1;

FIG. 5A shows an axonometric view of a detail of the articulated arm of the crane machine of FIG. 1; and

FIG. 5B shows a longitudinal section of the view shown in FIG. 5A and of the related detail.

### DESCRIPTION OF AN EMBODIMENT EXAMPLE OF THE INVENTION

With reference to the figures, a crane machine with articulated arm is designated as a whole with 1. It comprises a base frame 2 which is mounted on tracks 3; the crane machine 1 is then of self-propelled type. A rear portion is identified on the base frame 2 wherein an engine is arranged, covered in figures by a carter 4. The engine provides power both to the tracks 3 and to all actuating means, in particular to a pump connected to all actuators of hydraulic type existing on the crane machine 1 and on the articulated arm thereof, designated as a whole with 5.

The frame 2 further comprises a supporting base 6 which centrally projects from the base frame 2 itself. Such base 6 has an elongated shape and it is positioned tilted with respect to the vertical towards the carter 4 with the purpose of optimizing the space requirement; it can be fixed or revolving around a vertical axis even by 360°, and it comprises a base joint 7 on the top thereof.

Furthermore, the frame 2 comprises, at its own four side edges, four articulated legs 8, revolvingly connected to the body of frame 2 and equipped with a resting foot 9. Each leg 8, one for each edge, projects outwards diagonally with the purpose of increasing the resting base provided by the tracks, to contrast the pushes acting onto the articulated arm 5 during the working operations thereof. To this purpose, each leg 8 is actuated independently one from the other one by a respective hydraulic actuator of leg 10, so as to be able to adapt the positions of the legs 8 to irregular grounds.

During the rest and movement of the machine 1, the legs are gathered in a position inside the periphery of the frame 2, in order to minimize the peripheral space requirement of the machine 1. The legs 8 constitute means for stabilizing the base frame 2.

The articulated arm 5 is revolvingly connected to said supporting base 6 at said base joint 7. The supporting base 6 comprises a first arm actuator 21, fastened to the base 6 near the frame 2 and hooked to a first projection 31 of the articulated arm 5, in particular of a first section 11 of articulated arm 5.

In the present embodiment example, the actuators mentioned herein are of hydraulic type with piston and cylinder, able to extend its own length and hinged at the ends thereof. They are powdered by a not represented hydraulic pump, in turn actuated by said engine, through a hydraulic circuit, not represented in the drawings too.

The above-mentioned articulated arm 5 comprises then a first section 11 of arm, revolvingly connected to said supporting base 6 at a first proximal end thereof. In the present embodiment example, the first section 11 can be lengthened and to this purpose it has a telescopic structure, actuated in lengthening by a not represented actuator, included inside the box-like structure of the arm itself.

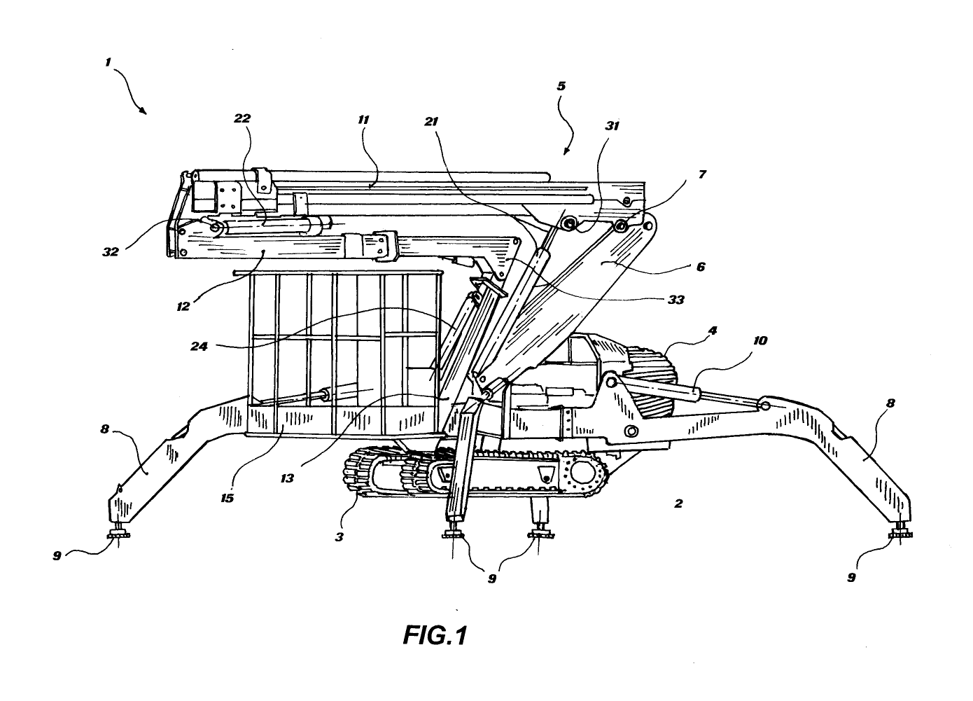

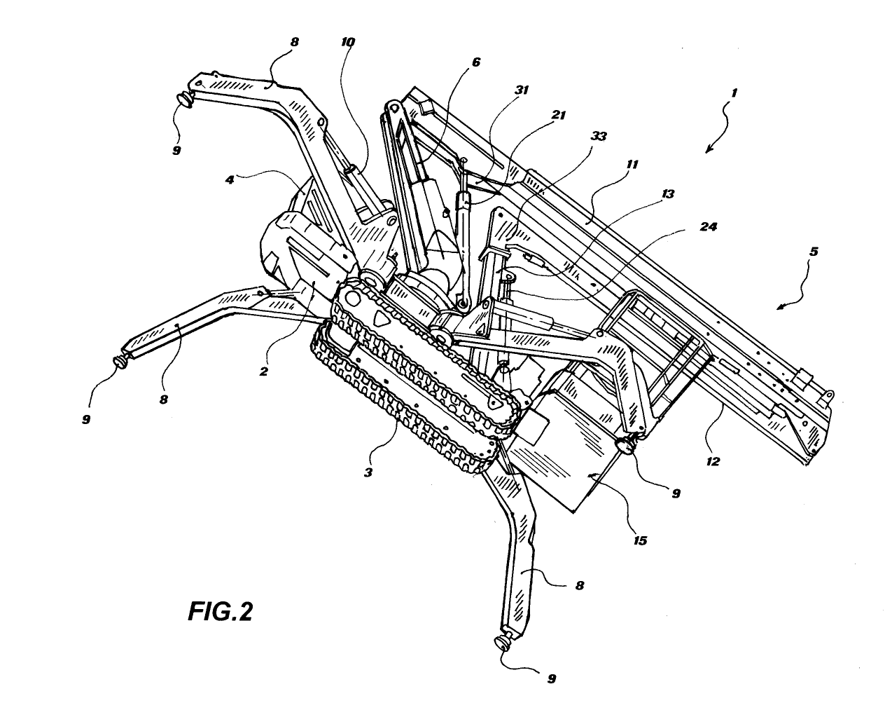

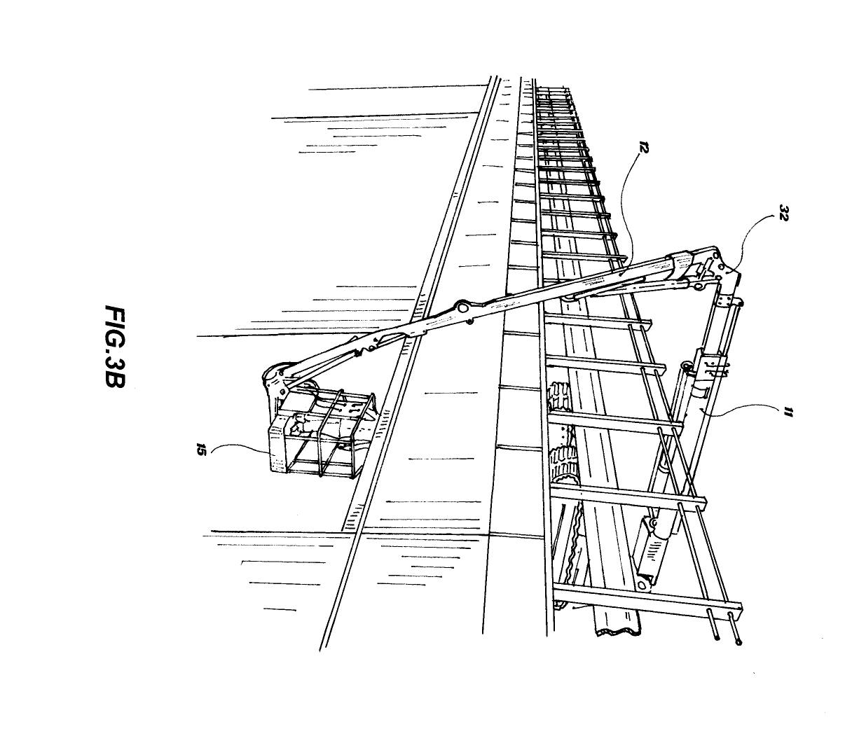

Thanks to the base structure 6 and to the first section 11, the latter can be rotated from a substantially horizontal rest position (FIGS. 1, 2) to a substantially vertical position (diagramme of FIG. 4), by forming an angle.

The articulated arm 5 then comprises a second intermediate section of articulated arm 12, revolvingly connected to a first distal end of said first section 11 at a second proximal end thereof, the latter having a second projection 32 thereto a second arm actuator 22 is connected, connected to the second section 12. Thanks to the shape of the sections and of the related projections, the second actuator 22 can rotate the second section 12 from a position substantially adhered to the first section 11 (FIGS. 1, 2, 3) to a position wherein, with said first section 11, it forms and angle of 180° with maximum extension.

It is meant that in particular operating configurations, on the distal end of the second section 12 an attachment for a hooking, a jaw, a gripper or any other working and/or transporting and laying device can be fastened in order to use the machine 1 substantially as a crane. Furthermore, in alternative embodiment examples, even the second section 12 could be extended in telescopic way.

In the present embodiment example, the articulated arm 5 instead comprises a third section 13 of articulated arm 5, revolvingly connected to a second distal end of said second section 12 at a third proximal end thereof on a third distal end thereof. To this purpose said second distal end comprises a third projection 33 a third arm actuator 23 is connected.

Thanks to this structure, the third section 13 can move, with respect to the second section 12, from an angle even smaller than 90° (FIGS. 1, 2) to an angle of 180° with maximum extension.

An attachment member 14, revolving too, can be hooked in jointed way to the third distal end of the third section 13, which member can be used to fasten a hooking a jaw, a gripper or any other working and/or transporting and laying device, but which in the present example constitutes a supporting arm for a a basket 15, intended to support and transport, for example, an operator. It is meant that even a platform can be used for the same purpose and even for transporting material.

In order to actuate the attachment member 14, there is a fourth arm actuator 24 between itself and the third section 13, fastened to the section at a hinge 34.

It is meant that all arm actuators mentioned so far in their entirety constitute actuating means, controlled by a control system, respectively connected to said supporting base 6 and to each one of said sections of articulated arm 5, for actuating and rotating each one of said sections of articulated arm 5 and a platform, a basket, a hooking or any working device apt to be operated by means of said articulated arm.

In the herein described embodiment example, the third section 13 of the articulated arm 5 is divided into two half-tracts revolving one with respect to the other one around the axis of the third section 13.

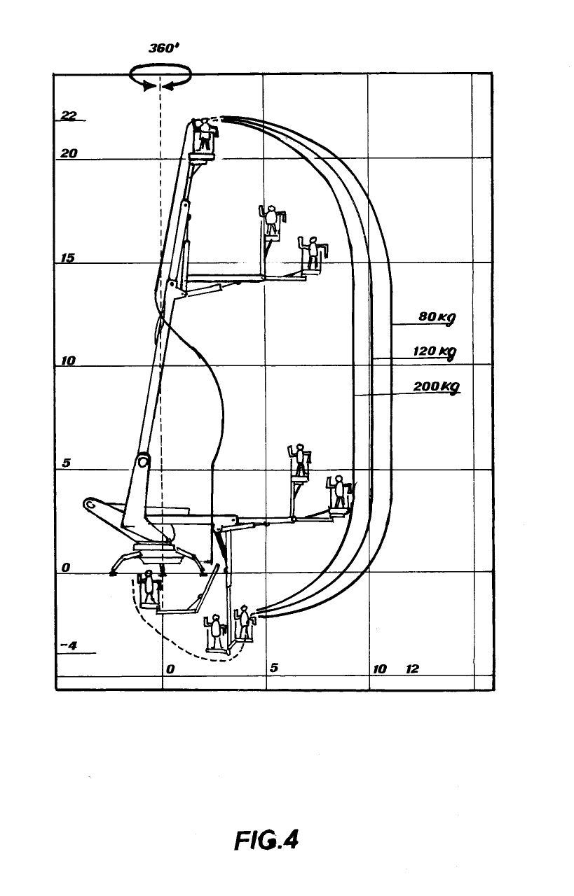

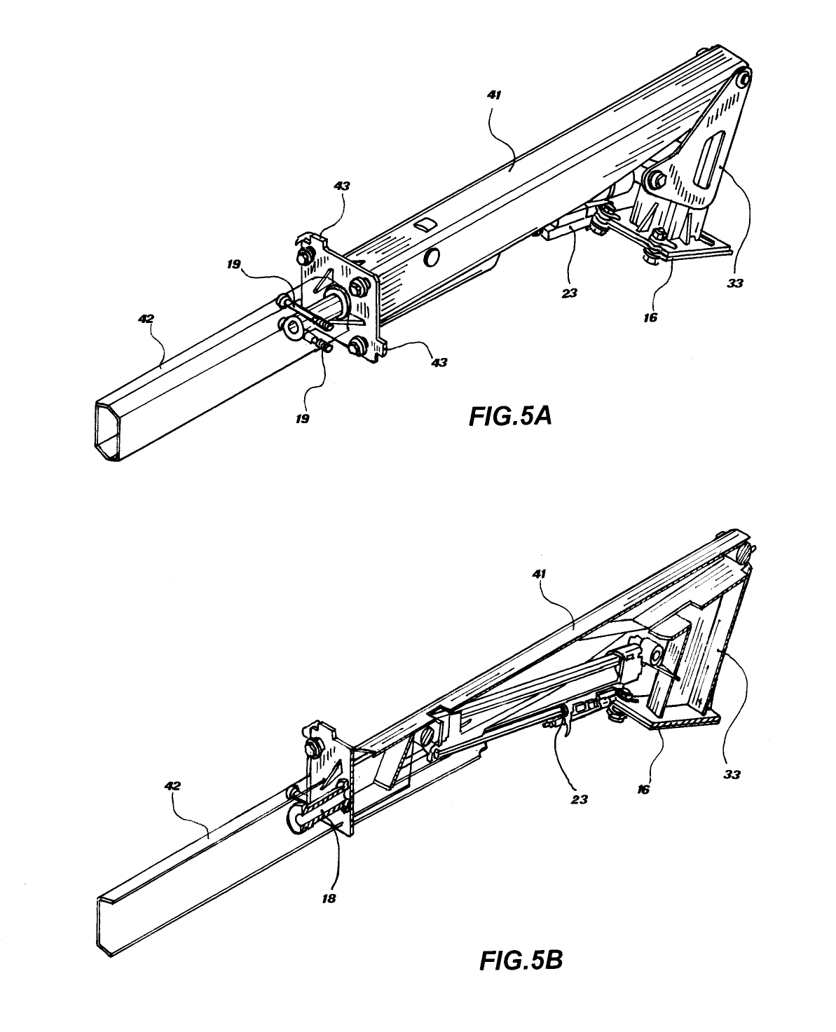

By referring to FIGS. 5A and 5B, the third section 13 comprises a first fixed half-tract 41 which is revolvingly connected to said third projection 33 which constitutes the second distal end of the second section 12. It is to be noted that said third projection 33 is fastened to the second section 12 by a first pair of hooking plates 16 with a system for fastening with bolts, which can be replaced by any other kind of hooking member.

The first fixed half-tract 41 is actuated by said third arm actuator 23, hinged inside thereof (FIG. 5B). The third section comprises then a second revolving half-tract 42, mounted as extension of the first half-tract 41. The two half-tracts 41, 42 are fastened one to the other one by means of a second pair of hooking plates 17 with a system for fastening with bolts; the second half-tract 42 then will comprise the hinge 34 and the fourth arm actuator 24, not visible in FIGS. 5A and 5B.

The plates of said second pair 17 comprise a through-hole and a fastening pin 18 constitutes an extension of the first half-tract 41. Therefore, by disassembling the fastening of the second pair 17 of plates, it is possible re-mounting the second half-tract 42 axially rotated by 180° with respect to the first half-tract 41, by rotating by 180° even the fourth arm actuator 24. The locking in the working position is obtained by inserting a pair of locking plugs 19, transversal to the pin 18 and provided with a system with nut and bolt for the fastening thereof. In order to ease the positioning and avoid an incorrect fastening, the two plates are provided with stops 43.

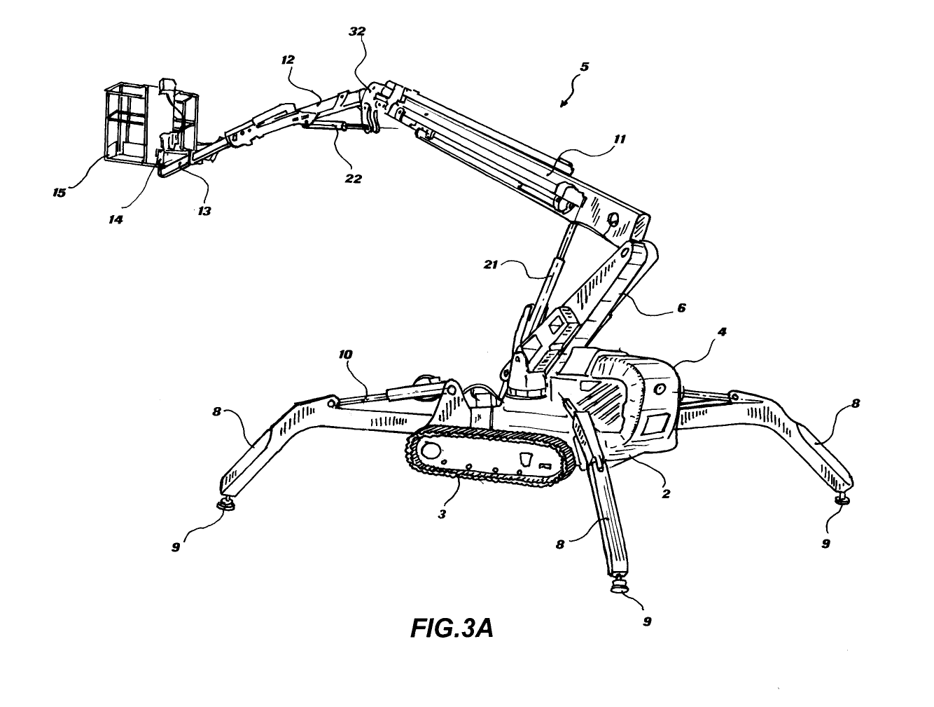

This inversion, which can be implemented by simply unscrewing the bolts of the plates and by rotating the second half-tract 42 before performing the hooking with the basket 15 even by a single operator provided with a minimum equipment, that is one or more keys, allows using the basket 15 (FIG. 3B) or a platform in an inverse position.

It is meant that, for a more complex workability, the rotation of the two half-tracts could be performed by a motorized system inserted inside the body of the fixed half-tract and acting onto the revolving half-tract, or viceversa, actuated electrically or hydraulically.

It is further meant that, in order to obtain the above-mentioned inversion, a different and/or additional section of articulated arm, for example the second section if the third section is not used, could be modified in order to obtain the above-described axial rotation.

To the above-described crane machine with articulated arm, a person skilled in the art, in order to satisfy the present needs, can introduce several modifications and variants all within the protection scope as defined by the following claims.

1. A crane machine with articulated arm comprising a base frame, having a supporting base for an articulated arm which in turn comprises:
a first section of articulated arm, revolvingly connected to said supporting base at a first proximal end thereof;
a second intermediate section of articulated arm, revolvingly connected to a first distal end of said first section at a second proximal end thereof;
a third section of articulated arm, revolvingly connected to a second distal end of said second section at a third proximal end thereof, comprising, on a third distal end thereof, an attachment for a platform, a basket, a hooking or any working device apt to be operated by means of said articulated arm; and
actuating means, controlled by a control system, respectively connected to said supporting base and to each one of said sections of articulated arm, for actuating and rotating each one of said sections of articulated arm and a platform, a basket, a hooking or any working device apt to be operated by means of said articulated arm,
wherein one or more of said sections of articulated arm are divided into two proximal and distal half-tracts revolving one with respect to the other one around the axis of the respective section of articulated arm, one proximal half-tract thereof is fixed whereas another distal half-tract is revolving, a revolving attachment member and additional actuating means for actuating the attachment member, fastened to said half-tract at a hinge, being connected to the distal half-tract; and
wherein the two half-tracts are fastened one to the other one by means of a pair of hooking plates comprising a through-hole and a fastening pin constitutes an extension of the first half-tract, so that by disassembling the fastening of the pair of plates it is possible re-mounting the second half-tract axially rotated by 180° with respect to the first half-tract, by rotating by 180° even the respective arm-actuating means.

2. The crane machine according to claim 1, wherein the base frame is self-propelled.

3. The crane machine according to claim 1, wherein the supporting base centrally projects from the base frame and it is revolving around a vertical axis.

4. The crane machine according to claim 1, wherein the base frame comprises, at its own four side edges, four articulated legs, revolvingly connected to the body of the base frame and equipped with a resting foot, each leg projecting from a respective edge outwards diagonally, with the purpose of increasing the resting base to contrast the pushes acting onto the articulated arm during the working operations thereof, each leg being actuated independently one from the other one by a respective leg hydraulic actuator.

5. The crane machine according to claim 1, wherein said actuating means comprises actuators of hydraulic type with piston and cylinder, able to extend its own length and hinged at the ends thereof.

6. The crane machine according to claim 1, wherein at least one of said sections of articulated arm, in particular the first section of articulated arm can be lengthened, having a telescopic structure.

7. The crane machine according to claim 1, wherein the third section of articulated arm is divided into two proximal and distal half-tracts revolving one with respect to the other one.

8. The crane machine according to claim 7, wherein said third section is divided into two proximal and distal half-tracts revolving one with respect to the other one around its own axis and it comprises:
a first fixed half-tract which is revolvingly connected to a projection constituting the distal end of the second section which is actuated by arm-actuating means; and
a second revolving half-tract, mounted as extension of the first half-tract.

9. The crane machine according to claim 1, wherein the locking in the working position is obtained by inserting a pair of locking plugs, transversal to the pin (18), the two plates being provided with stops (43) detecting the correct mounting positions.
